(19) United States
(12) Patent Application Publication
(10) Pub. No.: US 2009/0052308 A1
(43) Pub. Date: Feb. 26, 2009

(54) Apparatus for Accessing Storage Media

(76) Inventors: Guenter Tabor, Villingen-Schwenningen (DE); Rolf Dupper, Villingen-Schwenningen (DE); Reiner Baas, Steinach (DE)

Correspondence Address: Joseph J. Laks;Thomson Licensing LLC, 2 Independence Way, Patent Operations, PO Box 5312, PRINCETON, NJ, 08543, US

(21) Appl. No.: 12/083,659

(22) PCT Filed: Oct. 31, 2006
(86) PCT No.: PCT/EP2006/067913

§ 371 Date: Apr. 16, 2008

(30) Foreign Application Priority Data
Nov. 3, 2005 (EP) 05110322.4

(51) Int. Cl. G11B 17/00

(52) U.S. Cl. 369/244.1; G9B/17

(57) ABSTRACT

An apparatus for accessing storage media, having an actuator base and an actuator carrier, where for compact design and low material cost, an elastic connection pressing the actuator carrier against the actuator base is a straight piece of spring wire.

### FIELD OF THE INVENTION

The present invention relates to apparatus for accessing storage media, in particular to actuators on disk media pickups.

### BACKGROUND OF THE INVENTION

For accessing moving storage media, pickups are used which comprise a transducer involving an actuator on an actuator carrier mounted on an actuator base. For optical storage media, the transducer is an optical pickup involving generating a light beam, focusing the light beam onto a data layer of the storage medium and evaluating a returning light beam. For magnetic storage media, the transducer is a magnetic head brought into a well-defined small distance towards a surface of the moving storage medium. The actuator serves to quickly position at least part of the transducer relative to a desired access spot on the surface of the moving storage medium, in conditions where, due to imperfections of the storage medium shape suspension or movement, the desired access spot is deviating, in random or systematic manner, from a nominal position. The positioning of the actuator involves tracking, i.e. a servo-controlled positioning in a lateral direction parallel to the surface and orthogonal to information tracks thereon, so that the transducer correctly follows the information tracks, and it involves focusing or distance control, i.e. a servo-controlled positioning in a direction orthogonal to the surface, so that the transducer is maintained in the desired distance to the surface. In particular for the tracking alignment, the range of positions that the actuator allows to reach is typically smaller than the range needed to access all information tracks that exist on the medium surface. In these cases, in addition to the fast tracking control performed with the actuator, the pickup as a whole is mounted in such a way that it can be repositioned to access any desired information track on the medium. For this repositioning, linear sliding bearings or lever constructions are used. Because of the bigger mass involved in repositioning the pickup as a whole, the repositioning movement typically is more inert or slow than the short-range tracking motion by the actuator.

With increased storage media densities, the angular alignment of the transducer relative to the storage media surface, to the information track being accessed, and to the desired access spot thereon is of increasing importance. For compensating mechanical tolerances of the involved parts, the actuator is mounted using an actuator carrier and a separate actuator base. The actuator carrier and the actuator base are shaped in such a way that they allow to align the transducer angularly relative to the media surface. For this alignment, the actuator carrier and the actuator base have matching bent surfaces, e.g. cylindrical or spherical, by which one is seated in the other, an elastic connection e.g. in the form of a contact pressure spring, by which the actuator carrier is pressed against the actuator base, and alignment means like alignment screws or helical washers or eccentric bolts which allow to finely tune the relative position of the two.

For flat and compact pickups, using spiral springs for the elastic connection negatively influences the overall pickup dimensions, in particular the pickup thickness, regardless whether the springs are of compression or extension type. One possible approach to avoid spacious spiral springs is to design certain sections of the involved parts, namely the actuator carrier and the actuator base, to be elastic in themselves, but this makes the parts costly and/or complicated, difficult to manufacture, prone to mechanical fatigue and/or it introduces additional tolerances. Another possible approach to avoid spiral springs is to temporarily perform the contact pressing by an assembly tool into which actuator carrier and the actuator base are placed during assembly. This assumes that after alignment the two parts are mechanically fixed against each other, e.g. by glue or fixating lacquer so that they can then be removed from the assembly tool without loosing their aligned relative position; and in any case it makes the assembly tool more complicated and costly.

### INVENTION

According to the invention, a straight piece of transversally elastic material is used for the elastic connection between the actuator carrier and the actuator base. This has the advantage of needing a minimum of space and being cheap and waste-free to manufacture.

In an apparatus for accessing moving storage media which has a pickup with a transducer on an actuator carrier, an actuator base, and elastic connection means pressing the actuator carrier against the actuator base, according to the invention the elastic connection means are embodied as a contact pressure spring being a straight piece of transversally elastic material. This also advantageously overcomes the prejudice implicitly contained in the known designs, namely that the spatial direction defined by the straight line through the working points of the elastic connection means on the actuator carrier and on the actuator base must be in line with the direction of the desired pressing force vector. The transversally elastic material comprises “classical” materials such as spring steel or phosphorous bronze, as well as more “modern” ones such as fibre glass reinforced plastics, or carbon fibres, or compound materials made from any combination of the above.

Advantageously, the pressing spring is a piece of wire made of spring steel or phosphorous bronze. These materials and their handling as well as tools therefore are well known, the materials themselves are durable.

Advantageously, a middle section of the pressing spring leans against the actuator base and the two end sections of the pressing spring lean against the actuator carrier. By such a design, the restoring force of the spring acts in a symmetric way and the elasticity of the entire length of the spring is being used.

Advantageously, the contact pressure spring is arranged in a cavity of the actuator base which is shaped such that it prevents the unbent contact pressure spring from inadvertently falling out. This has the advantage that it eases manufacturing, in that half-finished pickups can, after insertion of the contact pressure spring, be relocated safely.

Advantageously, the cavity is sized substantially equal to the length and diameter of the contact pressure spring, respectively, in directions orthogonal to the direction in which the spring is being pressed, and at least a part of the cavity should be sized wider than the diameter of the contact pressure spring, in the direction of the pressing, allowing the spring to bend under the pressing. This has the advantage that the spring is optimally guided in its rest position as well as in the stressed state, and also that, by suitable shaping of the transition between the substantially equal part and the wider part of the cavity, the spring characteristic of the entire elastic connection can be varied, within certain limits, into a nonlinear dependency between the bending force and the resulting deflection or bent.

Advantageously, the actuator carrier has, on its ends cylindrical clearances of a radius or shape substantially equal to the diameter or shape of the contact pressure spring, allowing the actuator carrier to be hooked underneath the contact pressure spring. This has the advantage of guaranteeing a well-defined interlocking between the actuator carrier and the contact pressure spring, which contributes to avoid assembly errors.

Advantageously, the actuator carrier is seated in the actuator base by coaxial cylindrical seatings, and the pressing spring is oriented parallel to the axis of the seatings. By this design, the component of the restoring force which presses the actuator carrier against the actuator base is maximised. When the cylindrical seatings are situated at the outer end of the actuator carrier, the connection between the actuator carrier and the actuator base is maximally stiff in directions other than the allowed alignment motion of rotation around the axis of the seatings.

### DRAWINGS

The invention is illustrated in the subsequent drawings, using an example of accessing an optical disk. In this case the transducer takes the form of an optical pickup comprising a lens by which a light beam is focused on an information layer on or parallel to the surface of the disk, and the aforementioned tracking direction corresponds to a radial direction relative to the disc center.

In the figures:

FIG. 1 shows parts of an actuator base and a contact pressure spring according to the invention;

FIG. 2 shows parts of the actuator base of FIG. 1, with the contact pressure spring in its nominal position and with an actuator carrier in an interim position while it is being mounted;

FIG. 3 shows a detail of FIG. 2;

FIG. 4 shows parts of the actuator base of FIG. 1, with the contact pressure spring and the actuator carrier in nominal position;

FIG. 5 shows the content of FIG. 4 plus a mounted alignment screw;

FIG. 6 shows a complete pickup according to the invention;

FIG. 7 shows a detail of the pickup of FIG. 6;

FIG. 8 shows a section through a pickup according to the invention, with the actuator carrier in bottom position;

FIG. 9 shows a section through a pickup according to the invention, with the actuator carrier in top position; and

FIG. 10 shows the position of the sections of FIGS. 8 and 9 in a top view of the pickup according to the invention.

### EXEMPLARY EMBODIMENTS

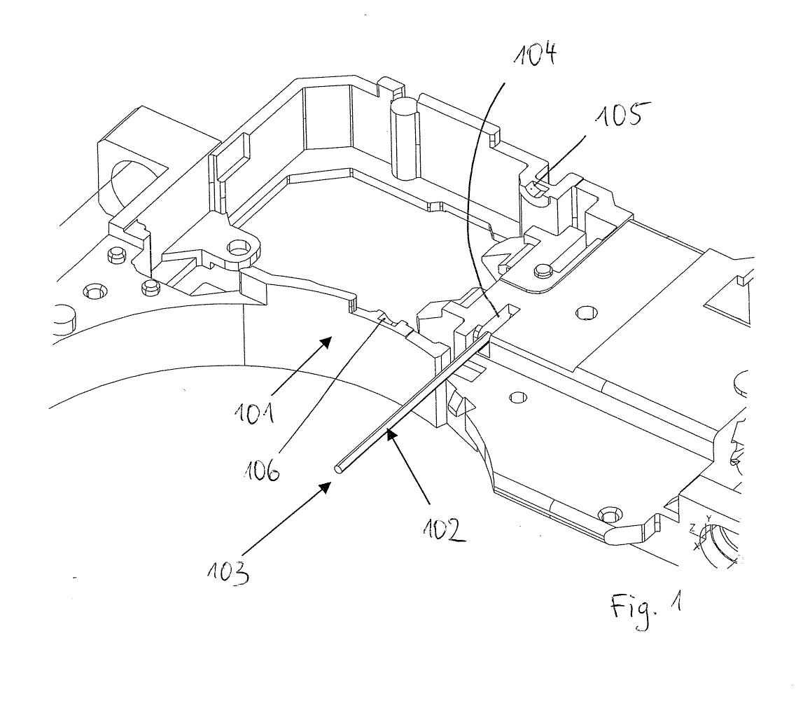

FIG. 1 shows parts of an actuator base 101 and a contact pressure spring 102 from an optical disk access apparatus according to the invention. The contact pressure spring 102 is shown prior to being inserted in axial direction 103 into a suitable hole or cavity 104 in the actuator base 101. The actuator base 101 has first clearances 105, 106 of cylindrically shaped bent surface for receiving corresponding pegs of an actuator carrier, not shown here. The hole 104 in the actuator base 101 is shaped such that if the contact pressure spring 102 is inserted thereinto, the middle section of the contact pressure spring 102 is held down, while the ends of the contact pressure spring 102 are free to elastically give way in an upward direction y, which is the focus direction orthogonal to the surface of the optical disk, not shown.

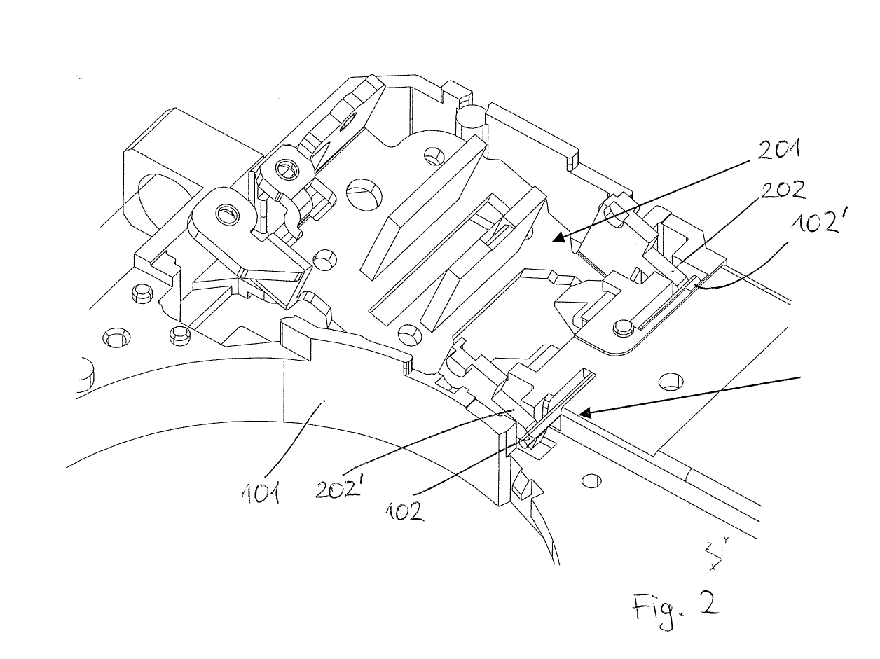

FIG. 2 shows parts of the actuator base 101 of FIG. 1, with the contact pressure spring 102, 102′ inserted into its nominal position, and with an actuator carrier 201 in an interim position while it is being mounted underneath the ends of the contact pressure spring 102, 102′. For this mounting, the actuator carrier 201 has two levers 202, 202′, by which it is hooked underneath the end 102, 102′ of the contact pressure spring.

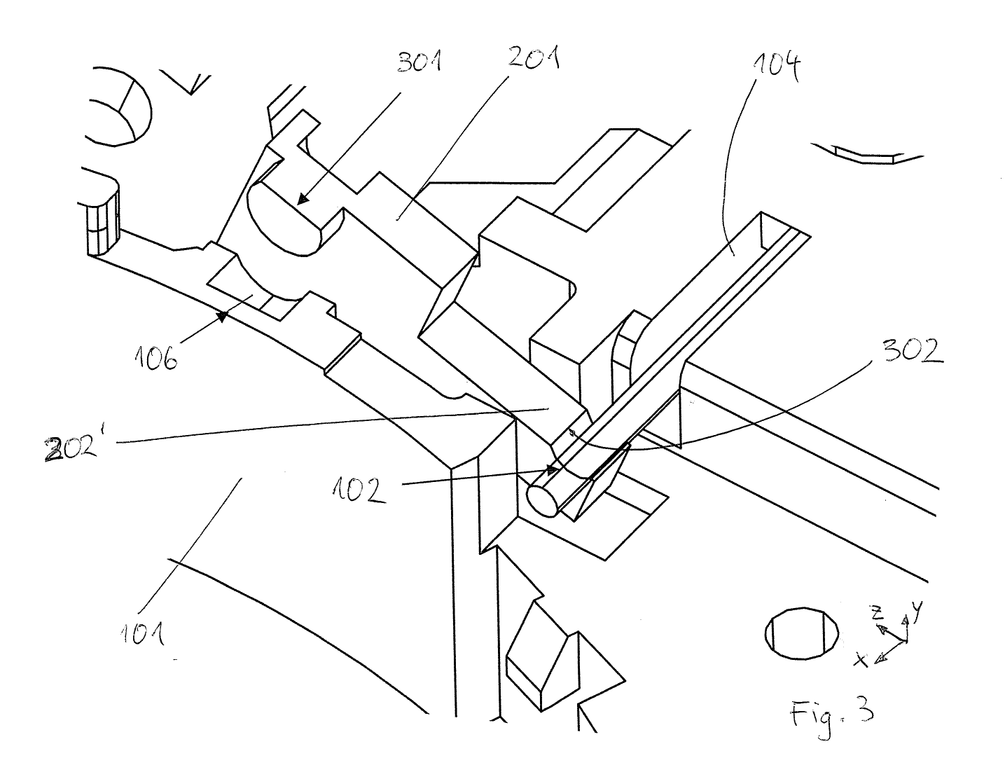

FIG. 3 shows a detail of FIG. 2 with parts of the actuator base 101 and parts of the actuator carrier 201. The left lever 202′ of the actuator carrier 201 has a second clearance 302 at its end. The second clearance 302 is of cylindrical shape and has a radius slightly bigger than the radius of the contact pressure spring 102; it enables the lever 202′ to be securely hooked underneath the end 102 of the contact pressure spring during assembly. The end of the right lever, not shown here, is shaped correspondingly. A left peg 301 of the actuator carrier 201 is shown slightly above the first clearance 106 by which it will be received when in its nominal position. FIG. 3 also shows in more detail the hole 104 in the actuator base 101 and how it holds the middle section of the contact pressure spring 102 down or away from the disk surface, while the end 102 of the contact pressure spring is free to elastically give way in the upward direction y.

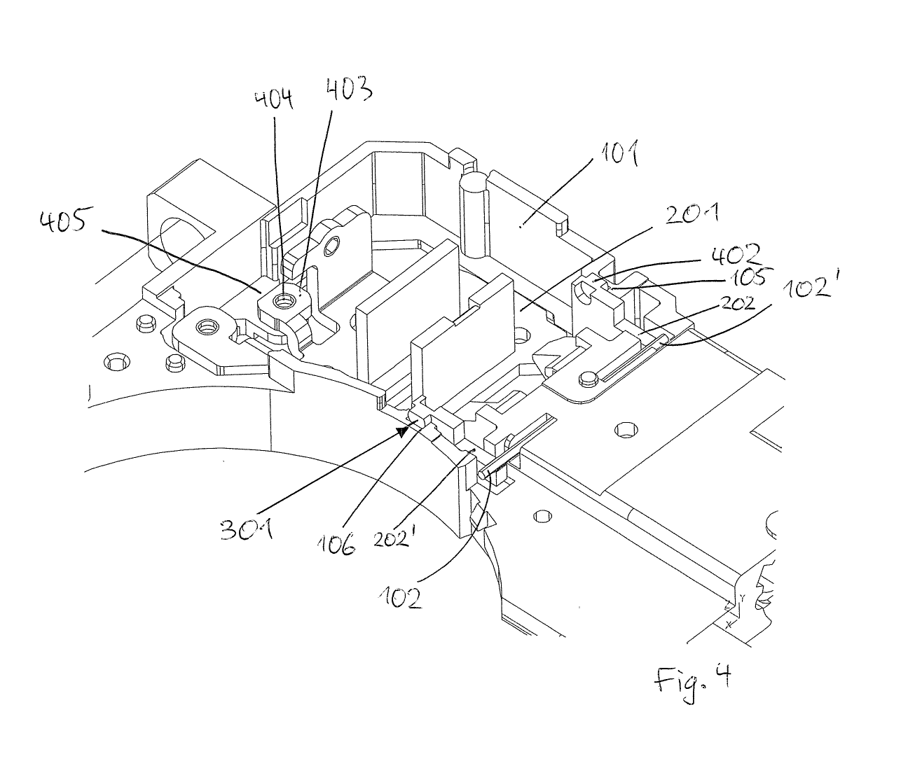

FIG. 4 shows parts of the actuator base 101 of FIG. 1, with the contact pressure spring 102, 102′ and the actuator carrier 201 in their nominal position. The pegs 301, 402 of the actuator carrier 201 are shown engaged with the first clearances 105, 106. Because of this engagement, the levers 202, 202′ of the actuator carrier 201 press the ends 102, 102′ of the contact pressure spring upwards in y direction when the actuator carrier 201 is in its nominal position. On its end opposite to the levers 202, 202′, the actuator carrier 201 has a first strap 403 with a threaded hole 404, the axis of which substantially runs in focus direction y. Because of the engagement of the pegs 301, 402 in the first clearances 105, 106, the downward-directed elastic pressure of the bent ends of the contact pressure spring 102, 102′, presses the first strap 403 upwards or towards the disk surface, against which the first strap 403 must be secured by an alignment screw, not shown here, which engages in the threaded hole 404 and leans against a second strap 405 which is part of the actuator base 101. By appropriately shaping that part of the actuator base 101, which holds down the central part of the contact pressure spring 102, 102′, the dependence between the displacement of the ends 102, 102′ of the contact pressure spring upwards from their neutral position and the downwards directed pressure can be influenced as desired, e.g. realizing a more than proportional pressure when the displacement approaches the end of its nominal range.

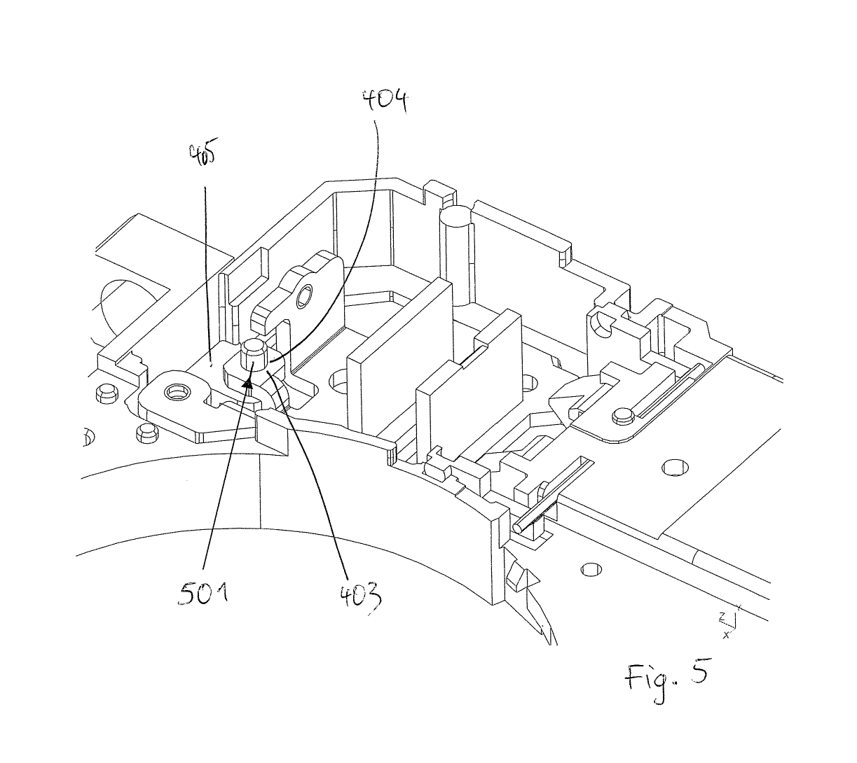

FIG. 5 shows the content of FIG. 4 plus a mounted alignment screw 501, the threaded tip of which is visible. The head of the alignment screw 501 is situated underneath the second strap 405 hence is not visible here. Turning the alignment screw 501 within the threaded hole 404 allows to pull the first strap 403 towards the second strap 405 to the extent desired.

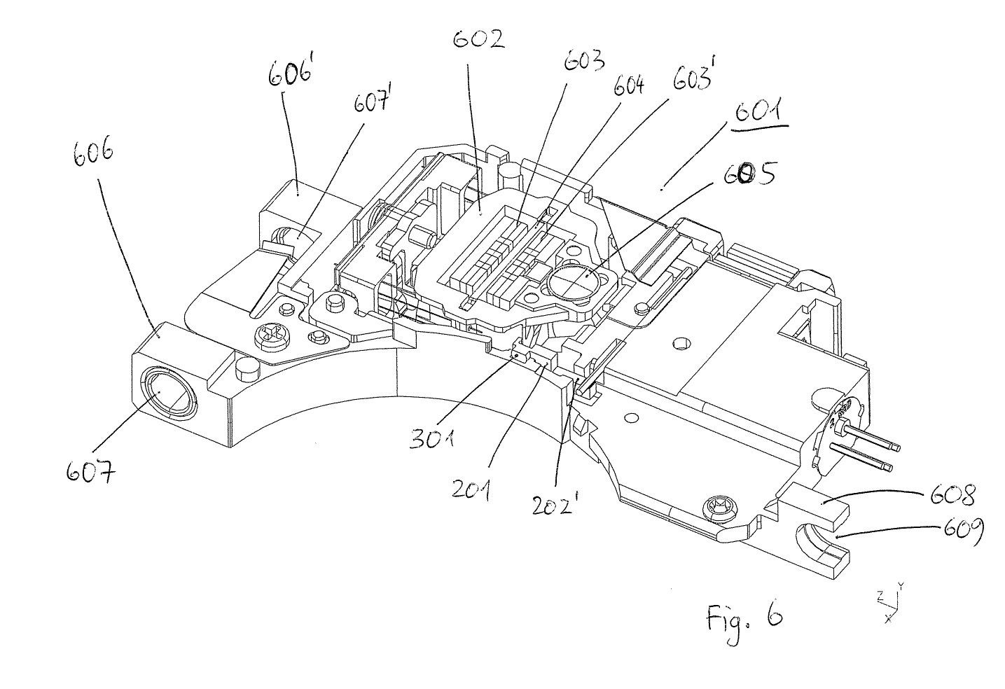

FIG. 6 shows a complete pickup 601 according to the invention. Of the actuator carrier 201, only the small part with the left peg 301 and the left lever 202′ is visible. The remainder of the actuator carrier 201 is hidden underneath an actuator 602, which comprises a coil carrying printed circuit board 604 and carries a lens 605. The printed circuit board 604 is permeated by a static magnetic field generated by two magnet arrangements 603, 603′, so that a current suitably fed to the coils, not shown, causes the actuator 602 with the lens 605 to move in focus direction y or in tracking direction x, or to tilt, i.e. to rotate around an axis parallel to the z direction. The pickup 601 also has first guiding straps 606, 606′ having repositioning rod holes 607, 607′ and a second guiding strap 608 having a semicircular guiding clearance 609, which enable the pickup 601 to slide in tracking direction x on two parallel repositioning rods, not shown, so that all information tracks on the disk, not shown, can be accessed.

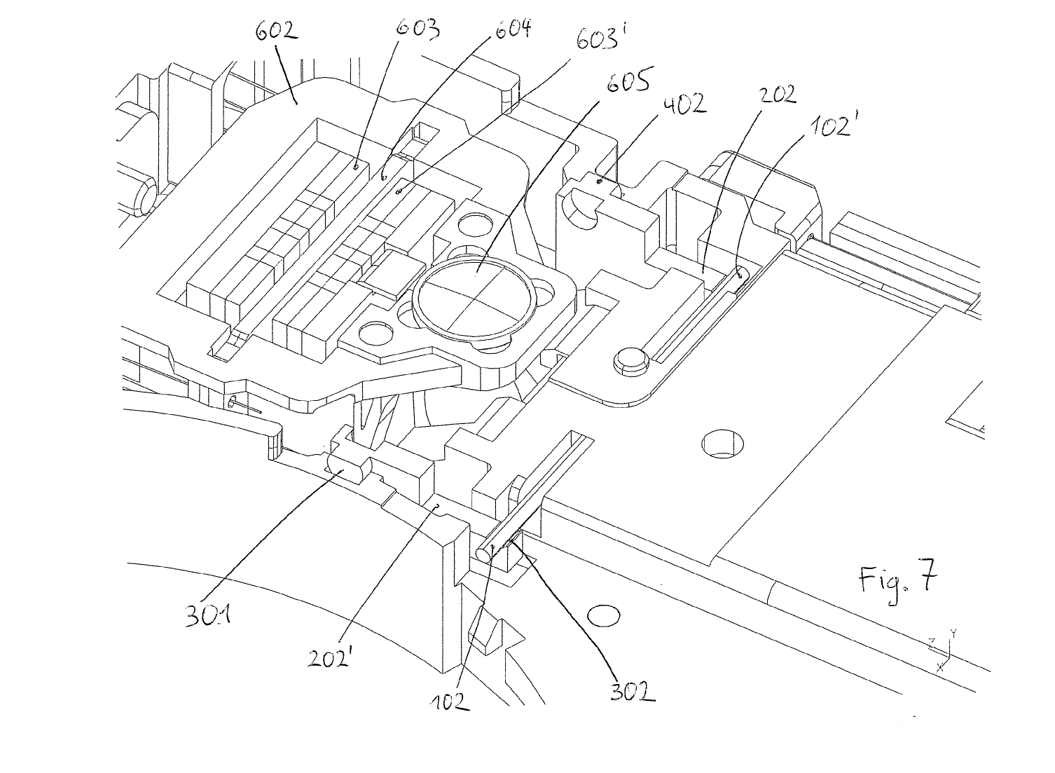

FIG. 7 shows a detail of the pickup of FIG. 6, namely the area in the vicinity of the lens 605. The second clearance 302 of the left lever 202′ can be seen hooked underneath the left end 102 of the contact pressure spring. Also, at its rear end near the rear end 102′ of the contact pressure spring, the cavity 104 ends at a wall of the actuator base 101, thus securing the contact pressure spring against axially sliding to the back. Securing the front end 102 of the contact pressure spring against axially sliding to the front, can for example be achieved by mounting a cover lid, not shown, with a bent strap standing in the way of the cavity 104, onto the actuator base 101.

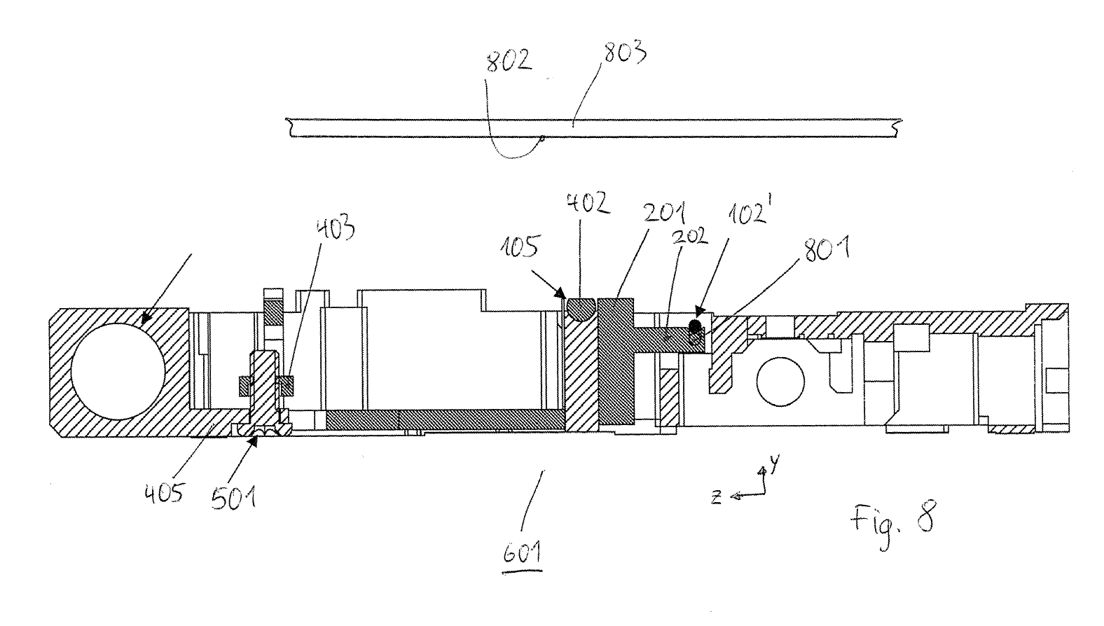

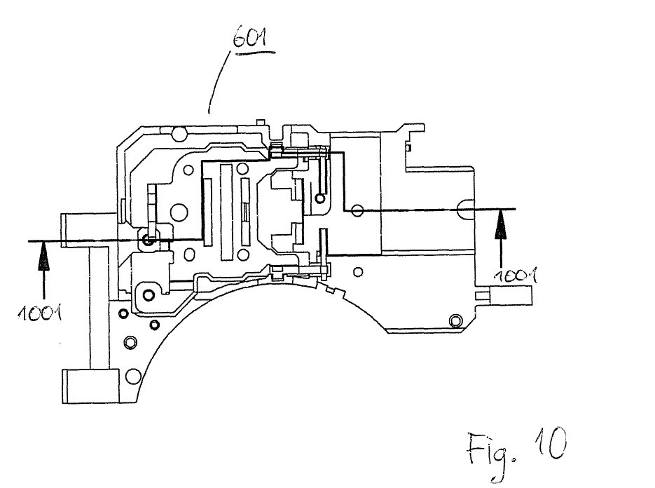

FIG. 8 shows a cross section through the pickup 601 along a line 1001 as indicated in the top view of FIG. 10. The actuator carrier 201, marked by fine hatching, is shown in a position when it is pulled downwards in focus direction y, by the alignment screw 501 acting on the first strap 403, nearly to the maximum possible. Because of the cylindrical seating of the right peg 402 in the first clearance 105, the pulling down force of the alignment screw 501 causes, via the right lever 202 being tilted upwards, the end 102′ of the contact pressure spring to be bent upwards towards the disk surface 802, i.e. in focus direction y, so that the black filled cross section of the contact pressure spring 102′ is displaced away from its unbent neutral position 801 indicated by the unfilled circle. The contact pressure spring 102, 102′ thus exercises a proportional reactive force downwards on the lever 202. A disk 803 is shown qualitatively in its position above the pickup 601.

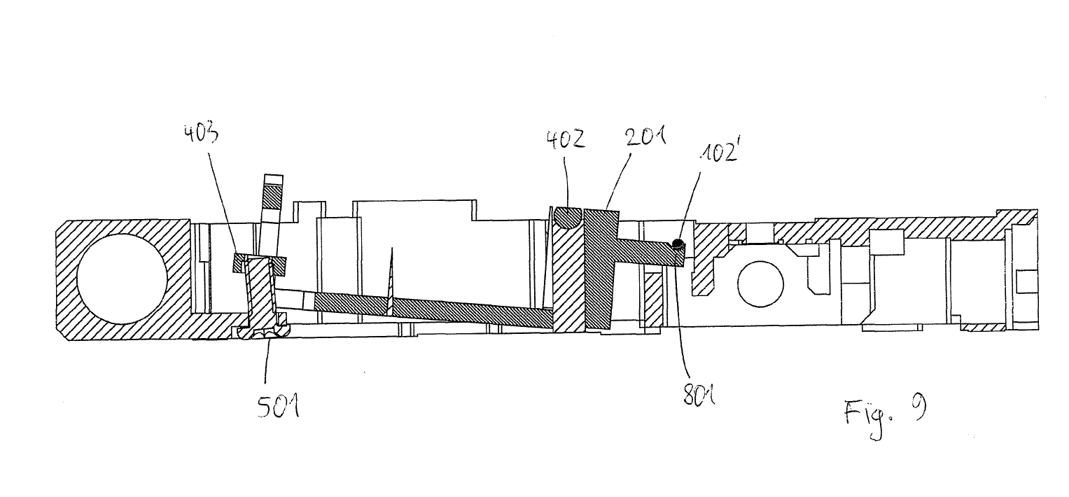

FIG. 9 shows the cross section along the same line 1001 as used for FIG. 8, but with the actuator carrier 201 in a position where the first strap 403 is in the topmost position, i.e. at the upper end of the alignment range that the alignment screw 501 allows to cover. The actuator carrier 201 being less pulled downwards causes the end 102′ of the contact pressure spring to be displaced less away from the neutral position 801. The reactive force of the spring 102′ is smaller in this case.

FIG. 10 shows as a thick line 1001 the position of the sections shown in FIGS. 8 and 9, as situated in a top view of the pickup 601.

Tracking and focus or distance servo means are needed for accessing moving storage media, regardless whether the access is a reading access or a writing access. Also, the alignment requirements between the transducer and the surface or layer of the storage medium are identical for both kinds of access. The same physical arrangement will likely be used for reading and for writing. Even if some parts differ between the reading part and the writing part, parts specific for reading and parts specific for writing will likely be mounted on the same actuator and will be aligned together using the elements of the invention. In this sense, an apparatus for reading according to this invention is also apt to be used for writing, if the storage medium allows, so that it actually constitutes an apparatus for accessing.

With other words, the invention relates to an apparatus 601 for accessing storage media 803, having an actuator base 101 and an actuator carrier 201, where for compact design and low material cost, an elastic connection pressing the actuator carrier 201 against the actuator base 101 is a straight piece of spring wire 102, 102′.

1. An apparatus for accessing a storage medium by an actuator, having an actuator carrier pressed against an actuator base by an elastic connection means, the actuator carrier being seated in the actuator base by coaxial cylindrical seating means arranged at both sides of the actuator, wherein the elastic connection means is formed as a straight piece of transversally elastic material oriented parallel to the axis of the seating means.

2. Apparatus according to claim 1, wherein the elastic connection means is a contact pressure spring made of spring steel or phosphorous bronze.

3. Apparatus according to claim 2, wherein a middle section of the contact pressure spring leans against the actuator base and two end sections of the contact pressure spring lean against the actuator carrier.

4. Apparatus according to claim 2, wherein the contact pressure spring is arranged in a cavity of the actuator base, and the cavity is shaped such that it prevents the unbent contact pressure spring from inadvertently falling out.

5. Apparatus according to claim 4, wherein the cavity, in directions orthogonal to a direction in which the actuator carrier is being pressed, is sized substantially equal to the length and diameter of the contact pressure spring, respectively, and in that in the direction in which the actuator carrier is being pressed, a part of the cavity is sized wider than the diameter of the contact pressure spring allowing it to bend under pressing.

6. Apparatus according to claim 2, wherein the actuator carrier has, on its ends cylindrical clearances of a radius substantially equal to the diameter of the contact pressure spring, allowing the actuator carrier to be hooked underneath the contact pressure spring.

7. Apparatus according to claim 1, wherein the seating means are formed by coaxial pegs of the actuator carrier supported at side walls of the actuator base.
